(19) United States
(12) Patent Application Publication
(10) Pub. No.: US 2007/0219766 A1
(43) Pub. Date: Sep. 20, 2007

(54) Computational fluid dynamics (CFD) coprocessor-enhanced system and method

(76) Inventors: Andrew Duggleby, Blacksburg, VA (US); Kenneth S. Ball, Blacksburg, VA (US); Evan Sewall, Cohoes, NY (US)

Correspondence Address: LATIMER IP LAW, LLP, 13873 PARK CENTER ROAD, SUITE 122, HERNDON, VA, 20171, US

(21) Appl. No.: 11/377,687

(22) Filed: Mar. 17, 2006

(51) Int. Cl. G06G 7/48

(52) U.S. Cl. 703/9

(57) ABSTRACT

The present invention provides a system, method and product for porting computationally complex CFD calculations to a coprocessor in order to decrease overall processing time. The system comprises a CPU in communication with a coprocessor over a high speed interconnect. In addition, an optional display may be provided for displaying the calculated flow field. The system and method include porting variables of governing equations from a CPU to a coprocessor; receiving calculated source terms from the coprocessor; and solving the governing equations at the CPU using the calculated source terms. In a further aspect, the CPU compresses the governing equations into combination of higher and/or lower order equations with fewer variables for porting to the coprocessor. The coprocessor receives the variables, iteratively solves for source terms of the equations using a plurality of parallel pipelines, and transfers the results to the CPU. In a further aspect, the coprocessor decompresses the received variables, solves for the source terms, and then compresses the results for transfer to the CPU. The CPU solves the governing equations using the calculated source terms. In a further aspect, the governing equations are compressed and solved using spectral methods. In another aspect, the coprocessor includes a reconfigurable computing device such as a Field Programmable Gate Array (FPGA). In yet another aspect, the coprocessor may be used for specific applications such as Navier-Stokes equations or Euler equations and may be configured to more quickly solve non-linear advection terms with efficient pipeline utilization.

### FIELD OF THE INVENTION

The present invention is generally directed toward a system and method for increasing the speed of Computational Fluid Dynamics (CFD) calculations. In particular, the present invention is directed toward a Computational Fluid Dynamics (CFD) coprocessor-supported system and method for use.

### BACKGROUND OF THE INVENTION

Computational Fluid Dynamics (CFD) is the study of dynamic fluid flow using computers. The primary computational challenges to CFD are how to discretize a continuous fluid in an accurate, fast and cost-effective manner. Currently, various CFD software packages exist (such as FLUENT™, STAR-CD™, etc.) to provide the ability to simulate and display flows of gases and liquids through computer modeling. CFD modelers enable virtual prototypes of a system or device to be constructed in order to evaluate the performance of a design. CFD software may be used for modeling a vast array of phenomena from blood flow through arteries, to movement of ocean currents and water flow in pipes. In general, the CFD market spans many different industries, including fields such as nanotechnology, food processing, internal combustion and gas turbine engine designs, large scale building designs, shipping, aerodynamics and propulsion, and many more.

CFD software may be used for modeling a variety of flows such as turbulent flows, laminar flows, multiphase flows, etc. Turbulent flows in particular typically have a large range of spatial and time scales. To solve for them all using Direct Numerical Simulation (DNS) is extremely time consuming and is therefore usually limited to simple flows. At the other extreme from DNS is Reynolds Averaged Navier Stokes (RANS) where all the spatial and time scales are averaged and the effect of turbulence is typically simulated through a k-epsilon model. However, it has been shown that RANS models do not accurately predict details of turbulent flows. Between RANS and DNS is Large Eddy Simulation (LES) where all of the large spatial and time scales are solved for, and the remaining small scales are simulated e.g., through a Smagorinsky eddy-viscosity subgrid scale model or a Dynamic Smagorinsky model.

Currently, a tremendous amount of research is focused on developing faster and more cost-effective CFD simulation tools. Many CFD simulations (especially for DNS) necessitate a large amount of processing time and computational resources. It is not uncommon, for example, for processing times to take several weeks or months to complete, and require expensive resources such as supercomputers. Because of time and cost constraints, many simulations are often limited to modeling “partial” flow-fields (e.g., around a wing of an aircraft) as opposed to “full” flow fields (e.g., around an entire aircraft). In some instances, instead of performing such time-intensive calculations, the coefficients are empirically measured in a laboratory setting. However, since such measurements cannot entirely account for actual-use conditions, they do not provide extremely accurate, nor optimal, solutions.

In general, CFD simulations involve the basic steps of: pre-processing, solving, and post-processing. In the pre-processing step, a flow model is created. This involves using e.g., various CAD packages for determining a suitable computational mesh and establishing boundary conditions as well as fluid properties. Processing of the flow calculations takes place during the solving step, where governing equations are applied. In the post-processing step, the results of the calculations are analyzed and organized into meaningful formats. For example, the results may be sent to a graphical processing unit (GPU) and/or visualization system for graphical display of flows.

CFD may be used for solving a variety of governing equations including, but not limited to: Euler and Navier-Stokes equations, which are selected depending upon the given fluid conditions and properties. For example, the Euler equations are usually applied to inviscid and compressible fluid flows, whereas the Navier-Stokes equations are used to describe the motion of viscous, incompressible, heat conducting fluids. Variables to be solved for in the Navier-Stokes equations include e.g., the velocity components, the fluid density, static pressure, and temperature. Because the flow in these equations may be assumed to be differentiable and continuous, the balances of mass, momentum and energy are usually expressed in terms of partial differential equations. However, solving the Navier-Stokes partial differential equations for non-steady turbulent flows is notoriously complex and extremely time consuming.

In order to solve partial differential equations, most CFD software typically uses a finite element approach, which is a numerical approximation method of solving initial boundary value problems. In this approach, the domain of interest is divided into a large number of control volumes, or sub-domains. In each control volume, the governing equations are applied in terms of algebraic equations that relate e.g., the velocity, pressure, and temperature in that volume to each of its immediate neighbors. Usually, the time derivative of the governing equations is discretized by a time-stepping scheme wherein boundary conditions are prescribed for every time step. The equations are then iteratively solved and the CFD software models the flow through the domain. Iterative solutions may perform a matrix inversion for each computational block at every time step. If a calculation involves hundreds to tens of thousands of computational blocks, and thousands of time steps are required to complete a calculation, millions of matrix inversion operations may ultimately need to be performed.

Many previous attempts to speed up CFD processing times have focused on parallel processing. In general, parallel processing divides up a plurality of tasks to be performed simultaneously by a cluster of computers. Although these techniques can provide faster processing times, there are also many drawbacks. For example, general-purpose CPUs typically only use a fraction of their overall processing power most of the time and therefore are not as efficient for computationally intensive, iterative, tasks. In addition, CPUs usually run at a clock rate that is faster than that which data can be transferred between devices, frequently leaving the processor in idle mode. Moreover, inter-processor communication introduces many synchronization, load balancing, latency, and bottlenecking issues regarding data transfer.

As an alternative to parallel processing, Field Programmable Gate Arrays (FPGAs) have been proposed by some to solve computationally complex equations. For example, Durbano et al. “Implementation of Three-Dimensional FPGA-Based FDTD Solvers: An Architectural Overview” (2003) used FPGAs in the electrical engineering field to solve Finite-Difference-Time-Domain (FDTD) algorithms with respect to Maxwell's equations. However, because the algorithms were not shown to be efficiently implemented in the hardware, increased processing speeds were not experimentally demonstrated.

Zhuo et al. “High Performance Linear Algebra Operations on Reconfigurable Systems” (2005), was able to achieve improved processing speeds using FPGAs in the field of superconducting. Such reconfigurable systems were initially chosen because of their design flexibility similar to software and performances similar to Application Specific Integrated Circuits (ASICs). The results of programming the FPGAs with standard linear algebra operations using Basic Linear Algebra Subprograms (BLAS) showed increased processing speeds on the order of 100 times faster than CPUs. The BLAS FPGA library essentially consisted of standard operations serving as “basic building blocks” for other numerical linear algebra applications.

Although FPGAs have continued to receive more consideration for speeding up applications, programming of existing algorithms remains a complex and time consuming task. As a result, the focus has shifted to “C-to-gates” compilers and “black box” application accelerators. Examples of these technologies include Starbridge Systems' VIVA™ compiler, and Clearspeed's Advance Board™, respectively. Many such systems, as well as the previously mentioned BLAS FPGA library, implement standard applications and codes and do not provide for user interaction. Thus, while such products may be suitable for a scientist or engineer who wants to speed up existing applications, or use a flexible “blackbox” to solve different problems day to day, they do not provide a dedicated solution for performing specific (e.g., CFD) applications with high computational efficiency.

In addition, even though reconfigurable computing has received noticeable attention in the electrical and computing fields as computational accelerators, the implementation of these devices designed to solve specific problems in mechanical fields, such as CFD, is not being extensively researched. At the same time, current CFD solutions remain limited by the long processing times required to run higher order (e.g., DNS or LES) simulations. It would be desirable to speed up complex higher order methods to bring their computational expenses down to requirements comparable to those currently used for lower order methods such as Reynolds Averaged Numerical Simulation (RANS). In addition, reducing the time required for calculating high-order solutions would be immediately marketable and would open up new avenues of research and design possibilities. For example, providing much faster processing times for CFD calculations would not only enable full flow field simulations, but would also allow improved design optimization and testing in an economical manner.

### SUMMARY OF THE INVENTION

In one aspect, a system for increasing the speed of Computational Fluid Dynamics (CFD) calculations is provided. In a further aspect, a system for increasing the speed of Large Eddy Simulation (LES) or Direct Numerical Simulation (DNS) of flows is also provided. The system comprises: a Central Processing Unit (CPU) in communication with a dedicated coprocessor over a high speed interconnect, and an optional display. The CPU is generally configured to create a CFD flow model, including: establishing governing equations and boundary conditions for a computational domain in accordance with conventional techniques. In addition, the CPU is configured to port computationally intensive source term calculations to the coprocessor. The CPU is further configured to receive the calculated source terms from the coprocessor and solve the governing equations using the calculated source terms. In a further aspect, the governing equations may be compressed into a combination of higher order and/or lower order equations with fewer variables for porting to the coprocessor. To solve the governing equations, the CPU may be configured to: perform a Transform on the governing equations; solve the governing equations using the calculated source terms; and perform an inverse Transform to yield results in physical space. In another aspect, the CPU may be configured to send the calculated results to a graphical processing unit (GPU) and/or a display.

In yet a further aspect, a system for increasing the speed of CFD calculations involving the Navier-Stokes or Euler equations is provided. The system comprises: a conventional CPU in communication with a dedicated coprocessor over a high speed interconnect, and an optional display. The CPU is configured to create a CFD flow model including the governing equations and boundary conditions for a computational domain in accordance with conventional techniques. Additionally, the CPU is configured to port computationally intensive advection calculations to the coprocessor. The CPU is further configured to receive the calculated source terms from the coprocessor and solve the Euler or Navier-Stokes equations using the calculated source terms. In a further aspect, the Euler or Navier-Stokes equations may be compressed into a combination of higher order and/or lower order equations (e.g., one fourth order equation and two second order equations) with fewer variables for porting to the coprocessor. To solve the Euler or Navier-Stokes equations, the CPU may further be configured to: perform a Transform on the equations; solve the governing equations using the calculated source terms; and perform an inverse Transform to yield results in physical space. In another aspect, the CPU may be configured to send the results to a graphical processing unit (GPU) and/or a display.

According to another aspect, a method for increasing the speed of Computational Fluid Dynamics (CFD) calculations is provided. In a further aspect, a method for increasing the speed of Large Eddy Simulation (LES) or Direct Numerical Simulation (DNS) of flows is also provided. The method includes creating a CFD flow model, including establishing governing equations and boundary conditions in accordance with conventional techniques. Additionally, the CPU ports computationally intensive calculations to the coprocessor. In a further aspect, the governing equations may be compressed into a combination of higher order and/or lower order equations with fewer variables for porting to the coprocessor. The CPU receives calculated source terms from the coprocessor and solves the governing equations using the calculated source terms. In a further aspect, the CPU may perform a Transform on the governing equations, solve the governing equations using the calculated source terms, and perform an inverse Transform to yield results in physical space. In addition, the results may be sent to a graphical processing unit (GPU) and/or a display.

According to yet a further aspect, a method for increasing the speed of Computational Fluid Dynamics (CFD) calculations involving Navier-Stokes or Euler equations is provided. The method includes creating a CFD flow model including establishing the governing equations and boundary conditions in accordance with conventional techniques. In addition, the CPU ports the computationally intensive advection calculations to the coprocessor. In one aspect, the Euler or Navier-Stokes equations are compressed for a portion of the domain into a combination of higher and/or lower order equations (e.g., one fourth order equation and two second order equations) with fewer variables. For each portion of the domain, the compressed variables are ported to the coprocessor over a high speed interconnect. The advection terms are calculated by the coprocessor and source ported back to the CPU over the high speed interconnect. At the CPU, the Euler or Navier-Stokes equations are solved using the calculated source terms. The Euler or Navier-Stokes equations may further be solved by performing a Transform on the governing equations, solving the equations using the calculated source terms, and performing an inverse Transform to yield results in the physical domain. In another aspect, the results may be sent to a graphical processing unit (GPU) and/or a display.

In another aspect of the present invention, a computer program product residing on a computer readable medium is provided including instructions for creating a CFD flow model including establishing governing equations and boundary conditions for a given computational domain in accordance with conventional techniques. Additionally, instructions are provided for porting computationally intensive source-term calculations (e.g., using a coprocessor-specific function call) to the coprocessor. In addition, instructions are provided for receiving the calculated source terms for the entire domain (e.g., using another coprocessor-specific function call) and solving the governing equations using the calculated source terms. In a further aspect, instructions are provided for compressing the governing equations into a combination of higher order and/or lower order equations for porting fewer variables to and from the coprocessor. To solve the governing equations, instructions may additionally be provided to: perform a Transform on the governing equations; solve the governing equations using the calculated source terms; and perform an inverse Transform to yield results in physical space. In another aspect, instructions may be provided to send the results to a graphical processing unit (GPU) and/or a display.

In another aspect, a coprocessor is provided configured to: receive variables of governing equations from a CPU; solve for source terms; and send the results back to the CPU. In a further aspect, the coprocessor is further configured to: decompress the received variables; calculate the source terms by performing derivatives in spectral space and non-linear multiplication and addition in physical space; and compress the results for transmission back to the CPU. The coprocessor may comprise one or more reconfigurable computing devices, which may additionally comprise one or more Field Programmable Gate Arrays (FPGAs). Preferably, the one or more FPGAs are specifically configured for processing complex portions of CFD calculations. For example, the FPGA may be specifically configured to process non-linear advection terms. In this way, a more cost effective coprocessor is provided for performing computationally intensive CFD calculations.

In addition, the high speed interconnect may include, for example, a high speed PCI-X bus or an Ethernet connection. The variables and/or source terms may be ported to and from the coprocessor using conventional Application Peripheral Interfaces (APIs). In another aspect, the coprocessor may be either co-located with the CPU or remote. For example, the coprocessor may reside on a card installed on the workstation or the coprocessor may be located remote from the CPU. In this way, the present invention provides a highly robust and cost effective means for performing CFD calculations that does not require expensive supercomputers or larger clusters of computers, and thus enables a wider variety of uses and applications.

### BRIEF DESCRIPTION OF THE DRAWINGS

FIG. 1 is a conceptual block diagram of the basic components of the present invention.

FIG. 2 is an exemplary block diagram of components of a Field Programmable Gate Array (FPGA) board.

FIG. 3 illustrates an example coprocessor layout in block diagram form.

FIGS. 4a and b are graphs comparing working error for algebraic and spectral methods

FIG. 5 is an illustrative flow chart of the operation of the CPU and coprocessor according to the principles of the invention.

FIG. 6 illustrates an exemplary flowchart of the operation of the coprocessor.

### DETAILED DESCRIPTION OF EMBODIMENTS OF THE INVENTION

The present invention will now be described with respect to one or more particular embodiments of the invention. The following detailed description is provided to give the reader a better understanding of certain details of embodiments of the invention depicted in the figures, and is not intended as a limitation on the full scope of the invention, as broadly disclosed herein.

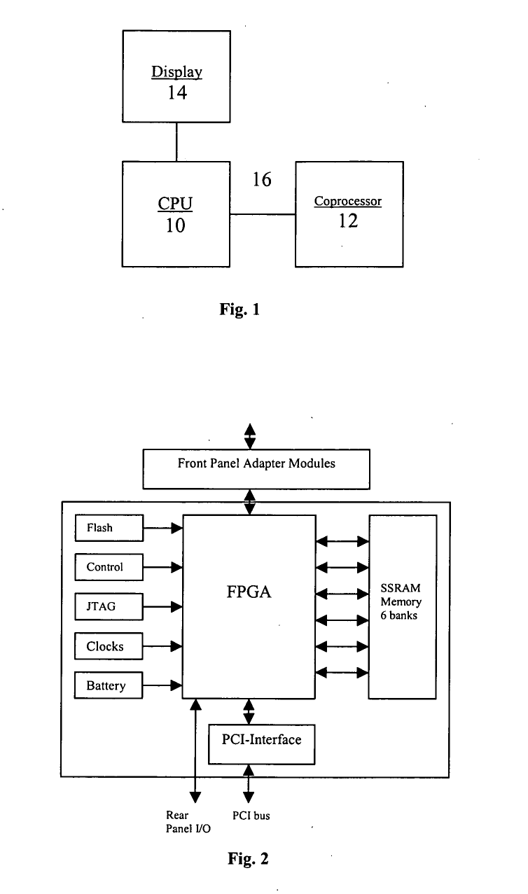

FIG. 1 displays the main components of an embodiment the present system in block diagram form. Element (10) represents a conventional CPU running a Windows or Linux-based operating system, for example. The CPU (10) may include a plurality of internal modules (not shown), such as conventional processing and memory modules, in communication with one another. The memory modules may include internal and/or external memory storage media for storage of computer programs and data. For example, internal storage media may include hard drives, memory buffers, etc., and external memory storage media may include CDs, DVDs, memory cards, etc. Additionally, CPU (10) may also include a user interface (not shown), such as a keyboard, mouse, joystick, touch screen, etc., and a conventional graphics processing unit (GPU, not shown). The CPU (10) is in communication with a dedicated coprocessor (12) over a high speed interconnect (16). High speed interconnect (16) may be a PCI-X bus, for example, or may include another type of connection, such as Ethernet. It is also to be understood that the CPU (10) and coprocessor (12) may be co-located or remote. The coprocessor (12) may be a reconfigurable computing device such as an FPGA. Alternatively, the coprocessor (12) may comprise an ASIC or cluster of computers operating in parallel. Optionally, the CPU (10) is coupled to a display (14). A visualization system may be provided including a 2×3 tiled display such as a Tungsten Deskside visualization cluster by Tungsten Graphics, LLC. In addition, conventional fluid dynamics visualization packages may be used.

It is expected that the principles of the present invention may encompass a variety of coprocessors. Although application to an FPGA-based coprocessor is illustrated below by way of example, it is understood that the equations and principles would also perform quite well on Application Specific Integrated Circuits (ASICs) or a cluster of computers operating in parallel.

In FIG. 2, the components of an exemplary FGPA-based coprocessor are shown. The coprocessor may be, for example, an ADM-XRC-4 board solution with Virtex-4 SX55 from Alpha-Data, San Jose, Calif. The ADM-XRC-4 is a high performance PCI mezzanine card based on Xilinx Virtex-4LX/SX range of platform FPGAs. The ADM card includes a high speed PCI interface, external memory, high density I/O and a comprehensive cross-platform API with support for WinNT/2000/XP, Linux, VxWorks with access to the full functionality of these hardware features. In addition, API drivers for WinNT, 2000, XP, Linux and VxWorks are included with template designs in VHDL and Verilog. The PCI interface may be compliant with a 66 MHz 64-bit PCI bus and 66 MHz 32-bit local bus and may operate at 528 MB/sec. SSRAM memory includes 24 Mbytes in 6 independent banks ZBT 6×1024K ×36 bits with optional additional 2 banks using XRM-ZBT. SDRAM memory includes up to 512 MB via XRM-DDR. The front I/O comprises up to 146 I/O via a range of XRM front panel adapters (including XRM Ethernet adapters) with a maximum data rate of 40 Gb/sec. The rear I/O comprises 64 I/O connections via PMC Pn4 connectors. Although FPGA-based coprocessors have been discussed by way of example, the coprocessor of the present invention is not intended to be limited to the above disclosure, and it is understood that any solution that contains an FPGA coprocessor will be suitable for the present invention. Alternatively, a Cray XD1 dual operation with Virtex-4 SX55 with a Hypertrans. interconnection at 6.4 GB/sec, or an SGI Altix 4700+RASC blade with Virtex 4 LX200 and a NUMAflex 6.4 GB/sec interconnection, or an equivalent machine, may be used.

The coprocessor may be designed and configured using e.g., conventional VHDL applications and APIs, respectively. For example, the Xilinx FPGA may be designed with the ISE Foundation™ or WebPACK™ technologies that provide intuitive HDL simulation capabilities. Available APIs include, among others, the PAVE™ and JBits™ APIs. Such APIs allow a user-written C++ application to write to, read from, and program the FPGA. JBits™ APIs also provide functions to interactively configure the coprocessor during operation. PAVE™ is a C++ API for configuring Xilinx FPGAs via SelectMAP™ or IEEE-1149.1 JTAG.

FIG. 3 provides an illustrative example of how a plurality of parallel pipelines may be programmed onto an FPGA. The logic may include spectral logic (discussed below) where the displayed configuration is not meant to be limiting, but is intended to show how a plurality of simple ‘add’ and ‘multiply’ operations may be performed at one time. For example, arrays of 64-bit pipelined floating point multiply's and add's may be used. Parallel means that multiple calculations can occur simultaneously, and pipelined means that each calculation is independent of any previous one and can thus be started before the result of the previous calculation is known. In other words, for each pipeline, a new independent calculation may be started every clock cycle, even though it takes 10 or 11 cycles to complete an operation. In addition, FPGA code (e.g., Verilog or VHDL) used for the 64-bit floating point operators are provided by Xilinx, Inc. in their ISE Foundation CORE, and thus provides a large portion of the complexity for coprocessing.

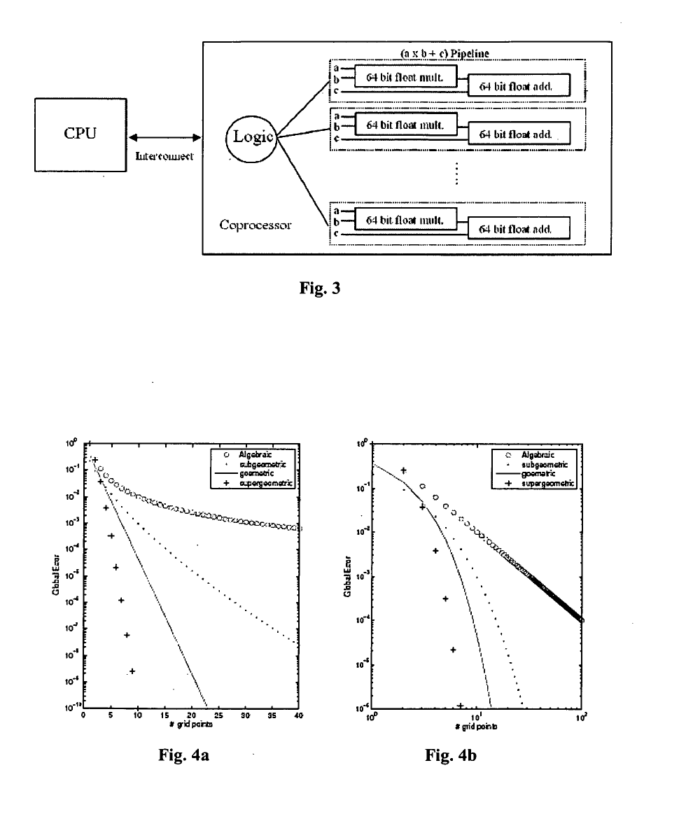

In a further aspect of the invention, the CFD calculations are processed using higher order methods. One class of higher order methods is called spectral methods, where the equations and variables are transformed from physical space to spectral space (e.g., frequency space for a Fourier Transform), resulting in an exponentially or geometrically converging method (see FIG. 4). Spectral methods provide a highly computationally effective approach for solving differential equations where the problem may be written as a series expansion, discretized, and formed into a matrix equation. The series expansion is discretized over the domain by writing the solution as a finite series of polynomials. The differential operator then becomes a matrix which operates on the expansion coefficients of the solution. Chebyshev polynomials or Legendre polynomials, for example, may be used as the basis functions.

As mentioned above, an attractive reason for solving problems with spectral methods is the exponential convergence to solution they afford (as opposed to finite difference methods which exhibit algebraic convergence and take much longer to solve). Another advantage is that when represented in matrix form, spectral methods conveniently allow for simultaneous (i.e., parallel) solution for all eigenvalues and eigenfunctions of the governing equation. Because of their highly parallel nature, spectral methods are particularly ideal for implementation in pipelines on FPGAs. Furthermore, because the working error with spectral methods is lower, 64 bit precision can be more easily implemented.

In addition to lower working errors associated with spectral methods, advantages are also realized in conjunction with a dedicated coprocessor. The first is that higher order methods facilitate compression of certain equations. For example, Navier-Stokes equations may be compressed from five second order partial differential equations (three velocities, pressure, temperature) to one fourth order, and two second order, partial differential equations. This reduces both overall memory size and communication latency to the coprocessor as only three variables need to be passed between the CPU and the coprocessor as opposed to five. The second benefit is that the equation solve step (matrix inversion) in the functional space is simple, so that the majority of the work typically performed in the solve step for standard methods is transferred to the transform and inverse transform between physical space and spectral space, which can be efficiently programmed into a coprocessor.

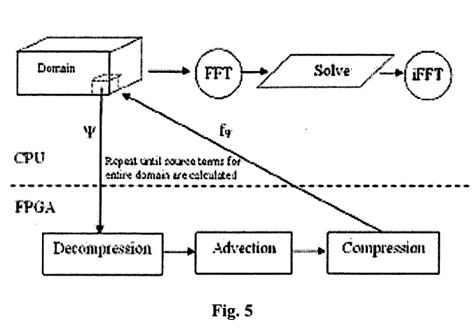

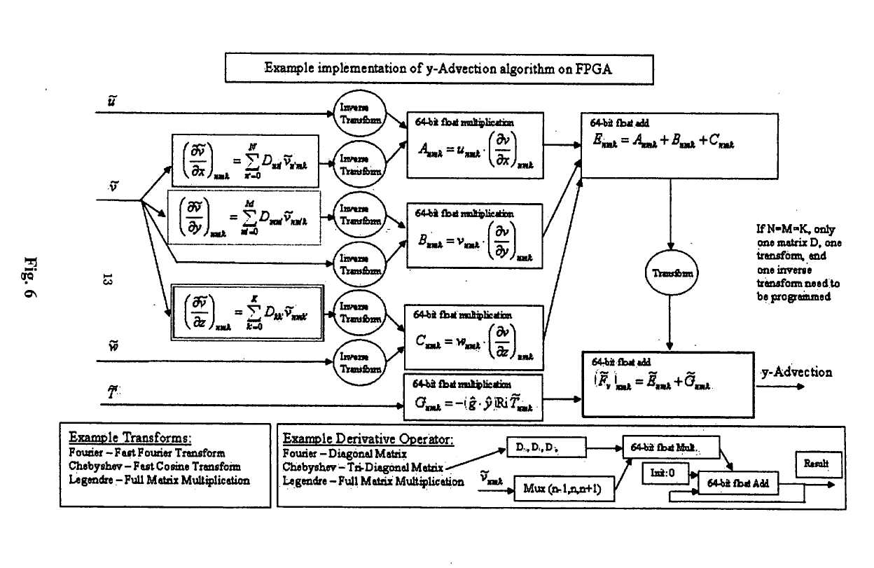

FIG. 5 provides an exemplary flowchart illustrating the basic principles of the present invention. As shown in this figure, the elements above the dashed line represent functions typically performed by the CPU and the elements below the dashed line represent functions typically performed by the coprocessor (in this case an FGPA). In addition to conventional preprocessing codes, the CPU is configured to port computationally complex portions of the equations to a dedicated coprocessor over a high speed interconnect. In order to reduce data transfer time and bottlenecking between the CPU to the coprocessor, it is desirable to limit the calculations on the FPGA to the computationally complex (and preferably highly parallelizeable) portions of the equation(s). For example, the coprocessor may be configured to perform the computationally intensive source term (or “right hand side”) calculations such as for the non-linear advection terms for the Navier-Stokes equations. To further reduce the amount of data transfer and communication latency, the CPU may also be configured to compress the equations to a combination of higher and/or lower order equations with fewer variables (represented in this figure by ψ) using e.g., spectral methods.

The coprocessor (below the dashed line) is configured to: iteratively perform computationally intensive source term calculations (e.g., Advection). In a further aspect, the coprocessor may also be configured to: decompress variables received from the CPU back to primitive variables (e.g., pressure, three velocities, and temperature); calculate advection terms; and compress the advection terms into source terms (represented by f_{ψ}) for transmission to the CPU. The data is transmitted back to the CPU over a high speed interconnect. When source terms for the entire domain are received from the coprocessor, the CPU is further configured to: perform a Transform (e.g., a fast Fourier Transform) on the governing equations; Solve the governing equations using the calculated source terms; and perform an inverse Transform to yield results in physical space. The results may further be sent to a GPU and/or a display (shown in FIG. 1) to graphically model the fluid flow.

Configuration of the CPU and coprocessor to perform the above functions may additionally involve the use of spectral method codes (written e.g., in C++ or FORTRAN) in addition to conventional CFD preprocessing and/or solving techniques. The CPU spectral method code may utilize e.g., a parallel Chebyshev spectral element code, and preferably involves: a domain decomposition of the flow, a global Schwartz/Multigrid preconditioner, and an efficient three dimensional banded solver (e.g., penta-diagonal for fourth order equations, and tridiagonal for second order equations). Domain decomposition involves decomposing the domain into manageable sizes to subdivide the source term calculations in an efficient manner. The subdomains are each solved with initial boundary conditions equal to the previous time step. Once all the local solution sweeps have occurred, a global iteration projection scheme (e.g., GMRES) may be applied. The coprocessor spectral code involves calculating computationally complex, e.g., advection, terms typically by performing derivatives in spectral space and non-linear multiplication and addition in physical space. The code may further provide for decompression of received variables into primitive variables as well as compression of the advection terms into source terms for transmission to the CPU.

In addition, the CPU may also be programmed with an interaction layer between the CPU and the coprocessor. The interaction layer includes drivers to interface with the coprocessor, so that when the computationally complex calculations need to be performed by the coprocessor, the following occurs: 1. coprocessor subroutine called (for a given subdomain); 2. Data transfer from CPU memory to coprocessor memory over high-speed interconnect; 3. Source terms are calculated (on the coprocessor); 4. Data transfer of source terms back to CPU memory over high-speed interconnect; and 5. Governing equations solved. In addition to an interaction layer on the CPU, a control scheme may further be implemented on the coprocessor to regulate the flow of data to and from the CPU.

### EXAMPLE

### System and Method for Solving the Navier-Stokes Equations Using an FPGA-Based Coprocessor

Although it is expected that the principles of the present invention may encompass a wide field of CFD equations and coprocessors, application to a spectral element code for solving the Navier-Stokes equations in conjunction with an FPGA-based coprocessor is illustrated below by way of non-limiting example.

Navier-Stokes Equations

The Navier-Stokes equations apply certain assumptions that cover the majority of fluid flows. These equations describe conservation of mass (1), conservation of momentum (2), and conservation of energy (3), shown below in non-dimensional form for an incompressible fluid with a velocity vector u=(u, v, w), pressure P, and temperature T, and gravity vector g.

$$\begin{matrix}\frac{\partial u}{\partial x} + \frac{\partial v}{\partial y} + \frac{\partial w}{\partial z} = 0 & ( 1 ) \\ \frac{\partial u}{\partial t} = - ∇ p - ( u \cdot ∇ ) u + \frac{1}{Re} {∇}^{2} u - Ri \frac{g}{‖ g ‖} T & ( 2 ) \\ \frac{\partial T}{\partial t} = - ( u \cdot ∇ ) T + \frac{1}{Re Pr} {∇}^{2} T & ( 3 )\end{matrix}$$

The Reynolds number

$$Re = \frac{UL}{v} \vert$$

is the ratio of inertia to viscous forces, the Prant1 number

$$Pr = \frac{v}{κ} \vert$$

is the ratio of viscous diffusion to thermal diffusion, and the Richardson number

$$Ri = \frac{α \ddot{g} ( δ T ) L}{{U}^{2}} \vert$$

is the ratio of buoyancy forces to kinetic energy.

Using a higher order method, these equations can be compressed in a single fourth order equation for wall-normal velocity v (4), and second order equation for wall-normal vorticity

$$η = \frac{\partial u}{\partial z} - \frac{\partial w}{\partial x} \vert$$

(5), and the remaining second order equation for temperature (3).

$$\begin{matrix}( {∇}^{4} + {∇}^{2} Re \frac{\partial }{\partial t} ) υ = - Re [ \begin{matrix}\frac{ {\partial }^{2}}{\partial y \partial x} ( ( u \cdot ∇ ) u ) + \frac{ {\partial }^{2}}{\partial y \partial z} ( ( u \cdot ∇ ) w ) + \\ {∇}_{⊥}^{2} ( ( u \cdot ∇ ) v ) - Ri {∇}_{⊥}^{2} T\end{matrix} ] \vert & ( 4 ) \\ ( {∇}^{2} + Re \frac{\partial }{\partial t} ) η = Re ( \frac{\partial }{\partial z} [ ( u \cdot ∇ ) u ] - \frac{\partial }{\partial x} [ ( u \cdot ∇ ) w ] ) & ( 5 )\end{matrix}$$

Where

$${∇}_{⊥}^{2} = \frac{{\partial }^{2}}{\partial {x}^{2}} + \frac{{\partial }^{2}}{\partial {z}^{2}} .$$

These three equations may be solved e.g., with a Chebyshev Spectral Method, where each variable is represented in a series solution of Chebyshev Polynomial (Ψₖ=cos (kcos⁼¹( [symbol] )) resulting in a 3D penta-diagonal, and two 3D tri-diagonal systems to solve in spectral space.

$$[ u , P , T ] ( x , y , z ) = {\sum }_{n , m , k}^{N , M , K} {[ \tilde{u} , \tilde{P} , \tilde{T} ]}_{nmk} {Ψ}_{n} ( x ) {Ψ}_{m} ( z ) {Ψ}_{k} ( y ) \qquad ( 6 )$$

The remaining velocities are decompressed out of the wall-normal velocity and vorticity through a second order Poisson equation (7) and (8)

$$\begin{matrix}{∇}_{⊥}^{2} {u}_{nkm} = \frac{{\partial }^{2} v}{\partial x \partial y} - \frac{\partial η}{\partial z} & ( 7 ) \\ {∇}_{⊥}^{2} {u}_{nkm} = - \frac{{\partial }^{2} v}{\partial z \partial y} + \frac{\partial η}{\partial x} \vert & ( 8 )\end{matrix}$$

In this example, the coprocessor is configured to serve as a dedicated Navier-Stokes processing engine where: Decompression of the ported equation(s) to the five primitive variables (pressure, three velocities, and temperature); Calculation of the non-linear advection terms; and Compression into source terms can be built into an automated circuit on the coprocessor (e.g., an FPGA). Turning back to FIG. 5, the compressed equation(s) may be repeatedly ported from the CPU to the coprocessor (in this case FPGA) for calculation of the source terms over the entire domain. In addition, it is pointed out that because the pressure, temperature and three velocities are compressed for communication to the coprocessor, computational latency and bottlenecking are effectively reduced.

As illustrated in more detail in FIG. 6, the vorticity, energy and fourth order formulations are separated out of the compressed equation(s) during the Decompression step. The Advection step, which is the most computationally complex, solves for the advection terms of the equations. During the Compression step, the source terms are combined for transfer back to the CPU over the high speed interconnect (shown in FIG. 1). The Advection process involves calculating the derivative of the velocities in spectral space, conducting an inverse Transform, and performing 64-bit float non-linear multiplication and 64-bit addition in physical space. Advantageously, the derivatives may be calculated using a spectral expansion in matrix form. Spectral expansions may include Chebyshev, Fourier, or Legendre, polynomials etc. For example, Chebyshev expansions may be solved using a Diagonal matrix, Fourier expansions with a Tri-Diagonal matrix, and Legendre expansions with a Full matrix multiplication. The matrices may be solved using e.g., any conventional parallel diagonal, or tridiagonal, solver. Similarly, the Transforms include Chebyshev, Fourier, or Legendre, etc., respectively. Moreover, the advection step may be simplified if N=M=K (where the same matrix D, Transform, and inverse Transform could be programmed on the coprocessor for all three directions).

When the source terms for the entire domain are received by the CPU, a Transform is performed on the compressed governing equations. The CPU solves the Navier-Stokes equations using the calculated source terms, and an inverse Transform is conducted to yield results in physical space. Furthermore, it is to be noted that although equations based on Cartesian coordinates have been used by way of illustration, the disclosure is not intended to be limited thereto and it should be understood that the equations may readily be modified to be used in cylindrical or spherical coordinate systems.

The efficient use of a dedicated coprocessor to accelerate source-term calculation of CFD equations using spectral methods as disclosed herein provides numerous advantages over current technologies in the field of computational fluid dynamics. Increased processing speeds on the order of 1,000 times serial-based CPUs and 10 times general purpose FPGAs will not only increase the productivity of current computational fluid simulations, but also opens up the use of new engineering techniques, such as optimization, to be used in realistic fluid flow problems. The present invention breaks through a significant barrier in an industry that is strictly limited by computational resources. This allows for both time-consuming calculations to be completed in a time frame that is small enough for current industry designers to consider. It also allows for those who execute large calculations in academic settings to simulate problems that are of the same time frame but are orders of magnitude larger. In addition, the calculations may be performed in a more cost effective manner in conjunction with conventional CPUs as opposed to expensive supercomputers or large clusters of computers.

While various preferred embodiments have been shown and described, it will be understood that there is no intent to limit the invention by such disclosure. Rather, the disclosure is intended to cover all modifications and alternative constructions falling within the spirit and scope of the invention as defined in the appended claims.

1. A system for increasing the speed of Computational Fluid Dynamics (CFD) calculations for a given domain and governed by a set of one or more equations, comprising:
a Central Processing Unit (CPU) configured to: create a CFD model including the set of governing equation(s) and boundary conditions;
a high-speed interconnect;
a coprocessor coupled to the CPU over the high speed interconnect and configured to calculate source terms for the governing equations for a portion of the domain; and
wherein the CPU is further configured to: port variables for the CFD calculation(s) to the coprocessor; receive calculated source terms from the coprocessor; and solve the governing equations using the calculated source terms.

2. The system of claim 1, wherein the CPU is further configured to compress the governing equations in order to port fewer, compressed, variables to the coprocessor.

3. The system of claim 2, wherein the equations are compressed using spectral methods.

4. The system of claim 2, wherein the coprocessor is further configured to: decompress the received variables, calculate the source terms, and compress the results for transfer back to the CPU.

5. The system of claim 1, wherein to solve the governing equations, the CPU is configured to: perform a Transform on the governing equations; solve the governing equations using the calculated source terms; and perform an inverse Transform to yield results in physical space.

6. The system of claim 5, wherein the Transform is a fast Fourier Transform.

7. The system of claim 6, wherein the Transform is a fast Cosine Transform.

8. The system of claim 1, wherein the source terms are calculated in substantially real time.

9. The system of claim 1, wherein the CPU and/or coprocessor are configured to solve the Navier-Stokes equations.

10. The system of claim 1, wherein the coprocessor comprises one or more reconfigurable computing devices.

11. The system of claim 10, wherein the one or more reconfigurable computing devices comprise Field Programmable Gate Arrays (FPGAs).

12. The system of claim 1, wherein the high speed interconnect comprises a high speed PCI bus.

13. The system of claim 1, wherein the high speed interconnect comprises an Ethernet connection.

14. The system of claim 1, further comprising a display and/or graphical processing unit (GPU) connected to the CPU.

15. A method for increasing the speed of Computational Fluid Dynamics (CFD) calculations performed by a CPU for a given domain and governed by a set of equations and boundary conditions, comprising the steps of:
a) porting variables of the governing equations for a portion of the domain from the CPU to a coprocessor over a high speed interconnect;
b) calculating source terms of the equations at the coprocessor;
c) porting the results back to the CPU over a high speed interconnect;
d) iteratively repeating steps a)-c) until source terms are calculated over the entire domain;
e) using the calculated source terms to solve the governing equations at the CPU.

16. The method of claim 15, further including the steps of compressing the governing equations into a combination of higher and/or lower order equations with fewer variables before step a).

17. The method of claim 16, wherein step b) further includes: decompressing the received variables; calculating the source terms; and compressing the results for transfer back to the CPU.

18. The method of claim 15, wherein step b) is performed in substantially real time.

19. The method of claim 15, wherein step e) comprises the steps of: performing a Transform on the governing equations; solving the governing equations using the calculated source terms; and performing an inverse Transform to yield results in physical space.

20. The method of claim 19, wherein the Transform is a fast Fourier Transform.

21. The method of claim 19, wherein the Transform is a fast Cosine Transform.

22. The method of claim 15, wherein the governing CFD calculations include the Navier-Stokes equations.

23. The method of claim 15, wherein the coprocessor includes one or more reconfigurable computing devices.

24. The method of claim 23, wherein the one or more reconfigurable computing devices comprise Field Programmable Gate Arrays (FPGAs).

25. The method of claim 15, further including step f): sending the results of the CFD calculations to a graphical processing unit (GPU) and/or display.

26. The method of claim 15, wherein the CFD calculations involve Large Eddy Simulation (LES) of turbulent flows.

27. The method of claim 15, wherein the CFD calculations involve Direct Numerical Simulation (DNS) of turbulent flows.

28. The method of claim 15, wherein the CFD calculations may be applied to incompressible fluids.

29. The method of claim 15, wherein the CFD calculations may be applied to compressible fluids.

30. A computer program product comprising:
a memory medium in communication with a CPU; and
a computer program stored on the memory medium and containing instructions for:
receiving Computational Fluid Dynamics (CFD) governing equations and boundary conditions for a computational domain;
porting variables of the equations from the CPU to a distinct coprocessor for portions of the domain;
receiving calculated source terms for portions of the domain at the CPU from the co-processor; and
solving the governing equations using the calculated source terms.

31. The computer program product of claim 30, further including instructions for compressing the governing equations into a combination of higher order and/or lower order equations with fewer variables for porting to the coprocessor.

32. The computer program product of claim 30, further including instructions for: performing a Transform on the governing equations before solving with the calculated source terms, and subsequently performing an inverse Transform to yield results in physical space.

33. The computer program product of claim 32, wherein the instructions for performing a Transform include instructions for performing a fast Fourier Transform.

34. The computer program product of claim 32, wherein the instructions for performing a Transform include instructions for performing a fast Cosine Transform.

35. The computer program product of claim 30, further including instructions for sending the results of the solved equations to a graphical processing unit (GPU) and/or display.

36. The computer program product of claim 30, further including coprocessor-specific instructions for updating and/or reconfiguring the coprocessor during operation.

37. A reconfigurable computing device for speeding up Computational Fluid Dynamics (CFD) calculations for a given computational domain and governed by a set of equation(s), the device configured to:
receive variables for the governing equation(s) for a portion of the domain;
calculate source terms for the equation(s); and
port out the results.

38. The reconfigurable computing device of claim 37, further configured to: decompress the received variables before calculating the source terms; and compressing the source terms before being ported out.

39. The reconfigurable computing device of claim 37, configured to calculate advection terms of Navier-Stokes equations.

40. The reconfigurable computing device of claim 37, comprising one or more Field Programmable Gate Arrays (FPGAs).
